(19) United States
(12) Patent Application Publication
(10) Pub. No.: US 2012/0267266 A1
(43) Pub. Date: Oct. 25, 2012

(54) MULTI-MEDIA STORAGE AND BUSINESS CARD BLANK

(76) Inventors: Richard Hunter, Chicago, IL (US); George Gilmartin, Plainfield, IL (US)

(21) Appl. No.: 13/089,796

(22) Filed: Apr. 19, 2011

(51) Int. Cl. B65D 85/00; B31F 1/00

(52) U.S. Cl. 206/307; 493/395

(57) ABSTRACT

There is provided in a first embodiment a holder for a printed card and multi-media device. The holder includes a card panel removably connected to a first panel. A second panel is connected to the first panel by a first side panel, such that the when folded the first, second and side panel form a space to accommodate the multi-media device. A second side panel is provided opposite the first side panel and may be folded connected to the first panel such that the holder can be maintained in a closed configuration.

### FIELD OF INVENTION

The present invention relates to a blank for forming a care to hold a multi-media storage device, such as a USB flash drive, and for providing a detachable business card.

### BACKGROUND OF THE INVENTION

The ability to effectively market a business or an individual has seen a variety of types of marketing media throughout the years. Still commonly used today are business cards combined with printed brochures. Since these are easy to hand out and distribute, especially at trade shows, at the businesses on-site, and easy to carry and transport. One of many associated problems with this combined marketing strategy is the mere fact that marketing brochures can be cumbersome or more importantly antiquity in the material contained therein. As businesses develop and grow the information about the business changes, sometimes daily. Each change may or should require a change in the marketing or brochure information. Similarly, with on-line marketing capabilities, a printed brochure is extremely static, and the business losses the opportunity sometimes to creatively provide information. It is often more effective to provide the marketing material electronically. While others have attempted to combine electronic media with business cards, these have fallen short in their effectiveness. There is thus a need to provide for an easier way to manufacture and supply a marketing tool that combines aids in combining a business card or informational card with a multi-media device in a single easy package. The multi-media device could have the electronic media preloaded, such that the end-user simply has to plug or load the multi-media device into a computer. This combined marketing material is extremely small and light weight, such that the end user is not faced with having to carry around bulky brochure. Similarly, the end user does not have the problem of misplacing the business card.

Due to the problems and issues addressed herein, there is a great need to improve upon them.

### SUMMARY OF INVENTION

This invention is a novel and innovative method of creating a holder for a card and a multi-media device. The card can be a business card or other index type card having printed material. The multi-media device can be any type of portable device such as but not limited to a USB flash drive, mini-disk, memory card, SD Card, Compact Flash, Smart Media Card, Memory Stick, SIM card, Mini SD Card, and the like. The holder is preferably manufactured from a single unitary blank material, such as cardboard or other similar material or design. The card is attached to the holder by a living perforated hinge that permits the card to be removable at any time. The multi-media device is also removable and secured to the holder by any well know means.

The holder in one embodiment includes first and second panels with first and second side panels. The first panel connects to the card panel by the detachable living hinge, while the second panel connects to the first panel by the first side panel. The second panel also has the means for securing a multi-media device thereto. The second side panel connects to the second panel and the second side panel is positioned at an end diametrically opposed to the first side panel. The card panel, first panel, second panel, first side panel, and the second side panel all share a pair of opposed parallel edges that are at right angles to the connections between each other.

In another embodiment, the holder includes first and second side panels and a first panel. The first and second side panels are separately secured to the card panel about one of the card panel edges. Each side panel is secured to the card panel by a detachable living hinge such that the card panel is removable from the side panels and such that the first and second side panels can be folded at an angle from the card panel. The first panel connects to the first side panel by a first living hinge such that the first panel can be folded from the first side panel and positioned over the card panel to create a interior region therebetween. The first panel further includes a slot adjacent a free edge defined opposite the first living hinge and the first panel further includes a means for securing a multi-media device thereto. An end flap is also provided and has. The end flap connects to the second side panel by a second living hinge such that the end flap can be folded from the second side panel and positioned against the first panel wherein the tab is aligned to insert into the slot. Thus when the first and second panels are folded into a position such that the tab is aligned and inserted into the slot the holder is configured into a closed configuration.

### BRIEF DESCRIPTION OF THE DRAWINGS

A fuller understanding of the foregoing may be had by reference to the accompanying drawings, wherein:

FIG. 1 is a perspective view of a first embodiment of the present invention illustrating a combined holder for a business card and multi-media storage device;

FIG. 2 is a perspective view of FIG. 1 illustrating the combined holder being partially opened to show the multi-media storage device;

FIG. 3 is a perspective view of FIG. 1 illustrating in one aspect the detachable business card and detachable multi-media storage device;

FIG. 4 is a top view of the combined holder from FIG. 1;

FIG. 5 is a side view of the detachable multi-media storage device with a partial side view of the holder from FIG. 1;

FIG. 6 is a perspective view of a second embodiment of the present invention illustrating a combined holder for a business card and multi-media storage device;

FIG. 7 is a perspective view of FIG. 6 illustrating the combined holder being partially opened;

FIG. 8 is a perspective view of FIG. 6 illustrating in one aspect the detachable multi-media storage device;

FIG. 9 is a top view of the combined holder from FIG. 6;

FIG. 10 is a bottom view of the combined holder from FIG. 6; and

FIG. 11 is a perspective view of FIG. 6 illustrating in one aspect the detachable business card.

### DETAILED DESCRIPTION OF THE INVENTION

While the invention is susceptible to embodiments in many different forms, there are shown in the drawings and will be described herein, in detail, the preferred embodiments of the present invention. It should be understood, however, that the present disclosure is to be considered an exemplification of the principles of the invention and is not intended to limit the spirit or scope of the invention and/or the embodiments illustrated.

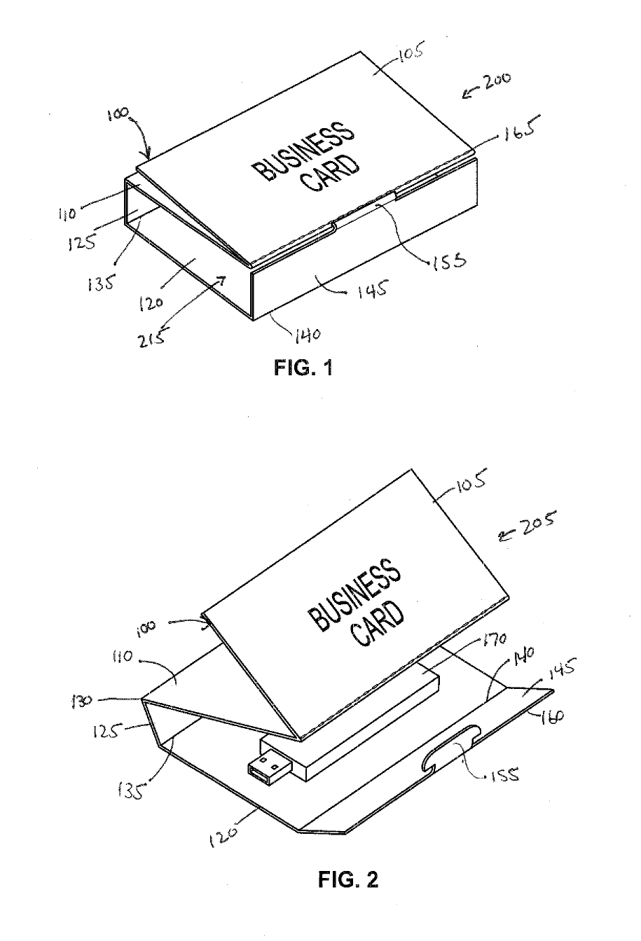

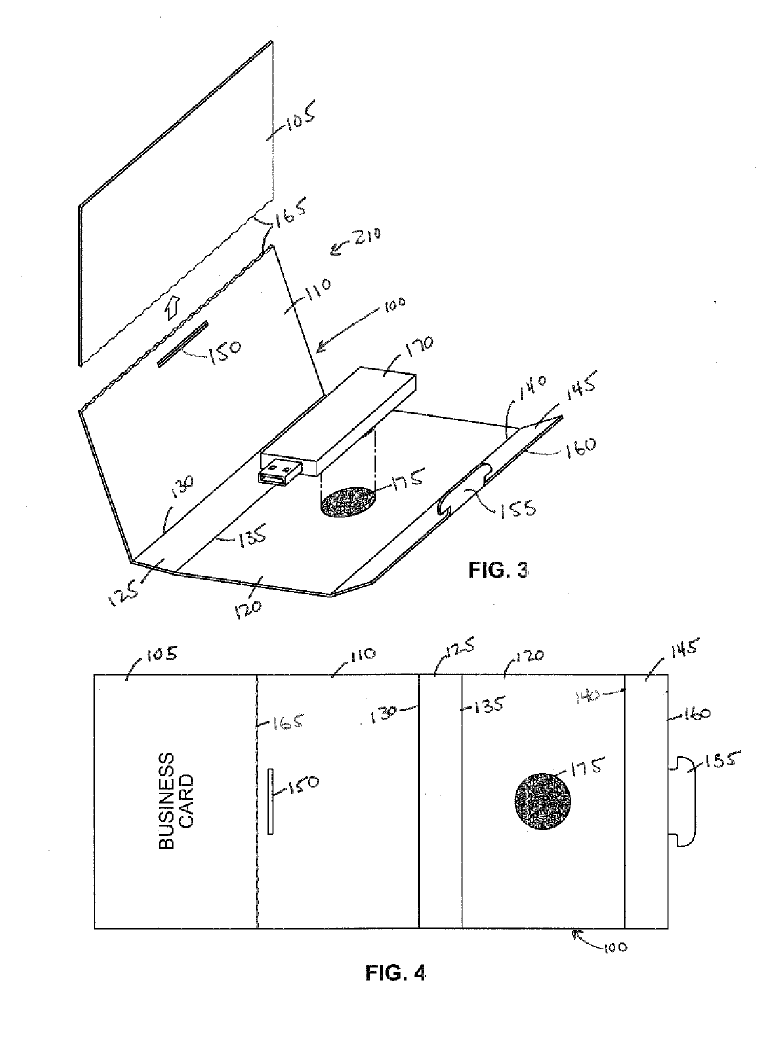

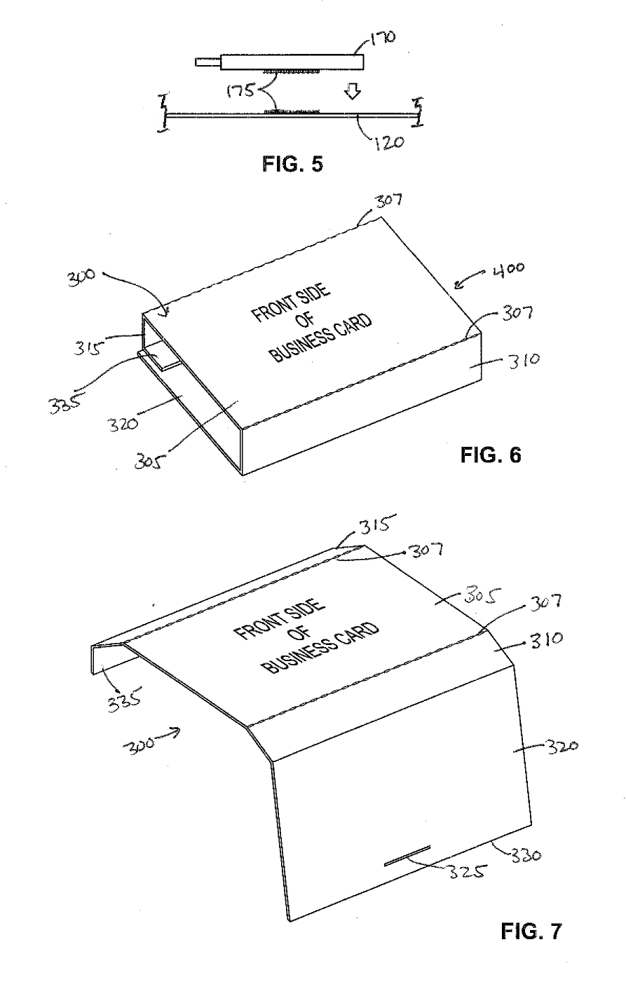

Referring now to FIGS. 1-5, there is shown a combined holder 100 for holding or accommodating a business or index card combined with a multi-media storage device that can store electronic media. As shown, more clearly in FIGS. 3 and 4, there is provided a card panel 105 detachably secured to a first panel 110. The first panel 110 is secured to a second panel 120 by a first side panel 125. Positioned between the first side panel 125 and the first and second panels 110 and 120 respectively are first and second hinges 130 and 135, respectively. Opposed from the side panel 125 and secured to the second panel 120 by a third hinge 140 is a second side panel 145. In one aspect of the first embodiment, a means for closing the combined holder 100 is provided. The closing means includes a slot 150 positioned in the first panel adjacent the detachable card panel 105 and a tab 155 attached to a free edge 160 of the second side panel 145.

The card panel 105 is preferable detachable from the first panel 110 by a perforated edge 165, however, other means of separation may be employed. The multi-media storage device 170 is easily removably attached to the second panel. This can be accomplished by using a means for attaching 175, such as, hook and loop systems, Velcro, adhesives, glues, epoxy, etc.

The combined holder is manufactured from a single blank, such as a cardboard or similar paper bound material. The multi-media storage device 170 can be a mini disk or USB flash drive device or similar.

FIGS. 1 through 3 show the combined holder 100 formed from a single blank. Various illustrations show the combined holder 100 from a closed configuration 200 into a partially opened configuration 205 and then to an open configuration 210. As illustrated in FIG. 1, the card panel 105 is folded towards or over the first panel 110. The two side panels (the first side panel 125 and the second side panel 145) are oppositely disposed with the first panel 110 and the second panel 120 to create an enclosed space 215 there-between. The enclosed space 215 is sized to accommodate the multi-media storage device 170. To keep the combined holder 100 in a closed configuration 200, the tab 155 is inserted through the slot 150.

The combined holder 100 when assembled can be handed out to individuals and will provide a business or index card with printed matter that can be easily removed from the combined holder 100. When opened, the combined holder 100 will also provide a easily removably multi-media device 170 then can have pre-loaded material thereon.

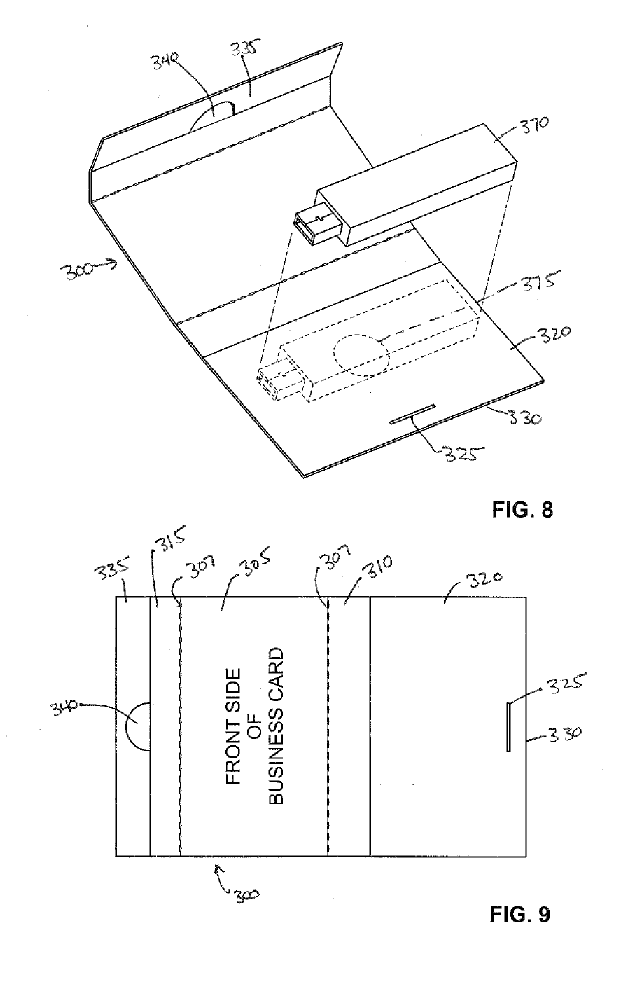

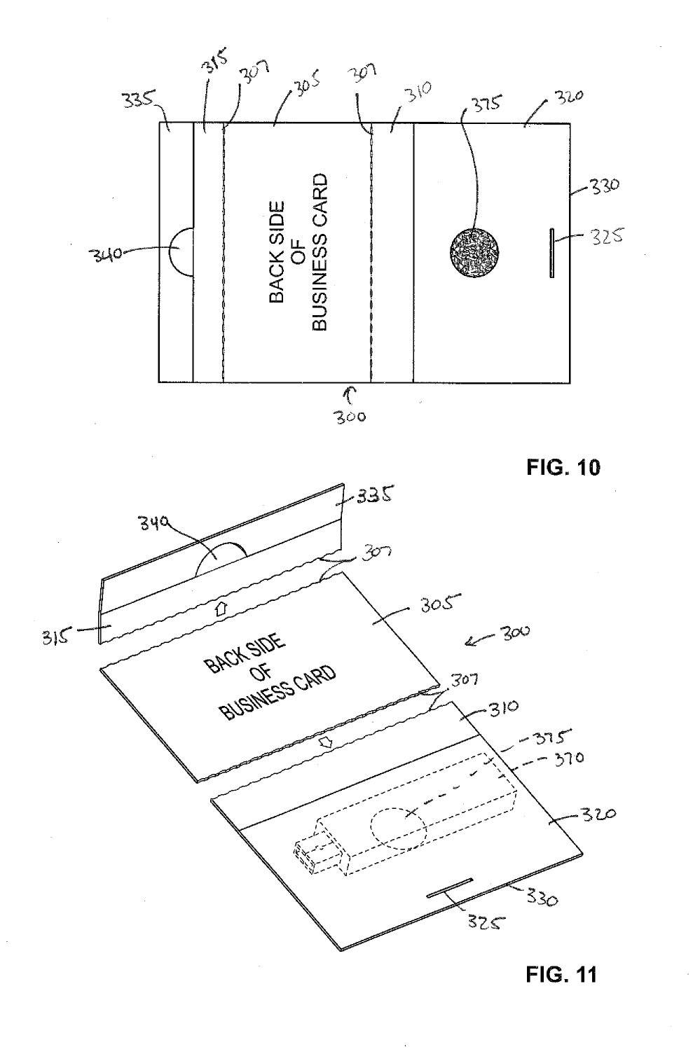

Referring now to FIGS. 6 through 11 there is a second embodiment of the present invention showing a combined holder 300 for holding or accommodating a business or index card combined with a multi-media storage device that can store electronic media. As shown, there is provided a card panel 305 detachably secured on one side to a first side panel 310 and on an opposite side to a second side panel 315 such that the first and second side panels are diametrically opposed to each other when assembled and in a closed configuration 400. The edges 307 between the card panel 305 and the first and second side panels are provided such that the card panel 305 can be detached from both the first and second side panels. In one aspect the edges are perforated.

Connected to the first side panel 310 is a second panel 320 which accommodates the multi-media storage device 370. The multi-media storage device 370 is removably attached to the second panel, by a means for attaching 375, such as, hook and loop systems, Velcro, adhesives, glues, epoxy, etc. The second panel 320 further includes a slot 325 positioned adjacent its free edge 330.

Connected to the second side panel 315 is an end flap 335 that includes a tab 340 grooved from a center region of the end flap 335. The tab 340 inserts into the slot 325 to keep the combined holder 300 in a closed configuration 400. In its closed configuration 400, the end flap 335 is folded be lie against an inside surface of the second panel 320.

The combined holder 300 is manufactured from a single blank, such as a cardboard or similar paper bound material.

It should be further stated the specific information shown in the drawings but not specifically mentioned above may be ascertained and read into the specification by virtue of a simple study of the drawings. Moreover, the invention is also not necessarily limited by the drawings or the specification as structural and functional equivalents may be contemplated and incorporated into the invention without departing from the spirit and scope of the novel concept of the invention. It is to be understood that no limitation with respect to the specific methods and apparatus illustrated herein is intended or should be inferred. It is, of course, intended to cover by the appended claims all such modifications as fall within the scope of the claims.

We claim:

1. A holder for a card and multi-media device, the holder comprising:
a card panel;
a first panel connecting to the card panel by a detachable living hinge, such that the card panel is removable therefrom;
a second panel connecting to the first panel by a first side panel, the second panel having a means for securing a multi-media device thereto, and wherein the first side panel includes a first side living hinge connecting a first edge of the first side panel to the second panel, and the first side panel further includes a second side living hinge connecting a second edge, diametrically opposite to said first edge, to the first panel;
a second side panel connecting to the second panel and the second side panel is positioned at an end diametrically opposed to the first side panel; and
wherein the card panel, first panel, second panel, first side panel, and the second side panel all share a pair of opposed parallel edges that are at right angles to the first and second living hinges.

2. The holder of claim 1, wherein the card panel is a removable business card.

3. The holder of claim 1, wherein the detachable living hinge is a perforated edge.

4. The holder of claim 1, wherein the holder is manufactured from a single unitary blank material.

5. The holder of claim 1, wherein the second side panel includes a third living hinge parallel to the first and second living hinges and connecting the second panel to the second side panel.

6. A method of forming a holder for a card and multi-media device from a blank as claimed in claim 1, comprising the steps of:
(a) folding the first and second panels about the first side panel towards each other to create a pocket to accommodate a multi-media device between the first and second panels,
(b) folding the second side panel to a position diametrically opposed to the first side panel,
(c) folding the card panel over a top portion defined by the first panel, and
(d) providing a means for maintaining the combined holder in a closed configuration in the second side panel and the first panel.

7. The holder of claim 6, wherein the means for maintaining the closed configuration further defined by having a slot positioned in the first panel and a corresponding tab attached to a free edge defined by the second side panel.

8. A holder for a card and multi-media device, the holder comprising:
a card panel;
a first panel connecting to the card panel by a detachable living hinge, such that the card panel is removable therefrom;
a second panel connecting to the first panel by a first side panel, the second panel having a means for securing a multi-media device thereto, and wherein the first side panel includes a first side living hinge connecting a first edge of the first side panel to the second panel, and the first side panel further includes a second side living hinge connecting a second edge, diametrically opposite to said first edge, to the first panel;
a second side panel connecting to the second panel and the second side panel is positioned at an end diametrically opposed to the first side panel, wherein the card panel, first panel, second panel, first side panel, and the second side panel all share a pair of opposed parallel edges that are right angles to the first and second living hinges; and
the holder forming a closed configuration defined by having the first and second panels folded about the first side panel towards each other to create a pocket to accommodate a multi-media device between the first and second panels, and the second side panel folded to a position diametrically opposed to the first side panel, and further having the card panel folded over a top portion defined by the first panel, and further providing a means for maintaining the combined holder in a closed configuration in the second side panel and the first panel.

9. The holder of claim 8, wherein the means for maintaining the closed configuration further defined by having a slot positioned in the first panel and a corresponding tab attached to a free edge defined by the second side panel.

10. The holder of claim 8, wherein the card panel is a removable business card.

11. The holder of claim 8, wherein the detachable living hinge is a perforated edge.

12. The holder of claim 8, wherein the holder is manufactured from a single unitary blank material.

13. A holder for a card and multi-media device, the holder comprising:
a card panel having a pair of card panel edges;
first and second side panels separately secured to the card panel about one of the card panel edges, each side panel being secured to said card panel by a detachable living hinge such that the card panel is removable from the side panels and such that the first and second side panels can be folded at an angle from the card panel;
a first panel connected to the first side panel by a first living hinge such that the first panel can be folded from the first side panel and positioned over the card panel to create a interior region therebetween, the first panel further including a slot adjacent a free edge defined opposite the first living hinge, the first panel further having a means for securing a multi-media device thereto;
an end flap having a tab, and said end flap further connected to the second side panel by a second living hinge such that the end flap can be folded from the second side panel and positioned against the first panel wherein said tab is aligned to insert into said slot,
whereby when the first and second panels are folded into a position such that said tab is aligned and inserted into said slot the holder is configured into a closed configuration.

14. The holder of claim 13, wherein the card panel is a removable business card.

15. The holder of claim 13, wherein the detachable living hinges are perforated edges

16. The holder of claim 13, wherein the holder is manufactured from a single unitary blank material.
